(19) United States
(12) Patent Application Publication
(10) Pub. No.: US 2026/0226792 A1
(43) Pub. Date: Aug. 6, 2026

(54) A MODULAR SIDE POST SYSTEM FOR A ROLL UP DOOR AND A METHOD FOR ARRANGING A MODULAR SIDE POST SYSTEM FOR A ROLL UP DOOR AT A DOOR HOLE IN A WALL

(71) Applicant: Assa Abloy Entrance Systems AB, Landskrona (SE)

(72) Inventors: Bruno VISEUR, Sirault (BE); Ralph EIKELENBERG, Meerbeke (BE); Piet STEVENS, Balegem (BE); Robin VAN DYCK, Heldergem (Haaltert) (BE); Patrik SCHOONJANS, Opwiik (BE); Lucas DE TROYER, Dendermonde (BE); Els DE DECKER, Nieuwerkerken (BE)

(21) Appl. No.: 19/146,437

(22) PCT Filed: Jan. 4, 2024
(86) PCT No.: PCT/EP2024/050142

§ 371 Date: Jul. 8, 2025

(30) Foreign Application Priority Data
Jan. 10, 2023 (SE) 2330013-0

(51) Int. Cl. E06B 9/58

(52) U.S. Cl. CPC E06B 9/58; E06B 2009/587

(57) ABSTRACT

The disclosure relates to a modular side post system (1) for a roll up door (2) comprising a first side post part (3,33) comprising a profile body (5,35) comprising a fastening surface (11) arranged to fasten around a door hole of a wall and a slit (12) arranged to guide a door curtain of the roll up door (2), a first fitting geometry (6,36) at a first peripheral end of the profile body (5,35), and a second fitting geometry (7,37) at second peripheral end of the profile body (5,35); at least one second side post part (4,34), wherein the second side post part is identical to the side post part (3,33), wherein the first fitting geometry (6,36) of the first side post part is adapted to fit the second fitting geometry (7,37) of the second side post part (4,34) so that the slit (12) of the first side post part (3,33) continues uninterrupted to the second side post part (4,34). The disclosure further relates to a method for arranging a modular side post system (1) for a roll up door (2) at a door hole in a wall.

### TECHNICAL FIELD

The present disclosure relates to a modular side post system for a roll up door and a method for arranging a modular side post system for a roll up door at a door hole in a wall.

More specifically, the disclosure relates to a modular side post system for a roll up door and a method for arranging a modular side post system for a roll up door at a door hole in a wall as defined in the introductory parts of the independent claims.

### BACKGROUND ART

In a typical High Speed Roll Up Door the side post or side guide construction consists of long profiles in folded sheet metal and/or extruded material. The length of these side guides is approximately the same as the door daylight height, which can be over 6 meters high.

Generally, this type of doors are made-to-measure and the profiles are cut to length from standard length profiles. The long profiles of which the side posts are constructed pose several challenges to the manufacturer, transporter and installer.

The long parts of which the side posts are made of have several disadvantages.

Long parts are difficult to move around leading to expensive material handling costs.

Further, the profiles are cut from standard length stock pieces. Cut-off pieces below 2 meters of length typically cannot be re-used because they are shorter than the general door height. This generates a lot of waste material.

The packaging and shipping size pose problems. Products are packed on custom pallets or racks of several meters length for shipping to the customer installation site, making the shipment very expensive. Even for replacing a single part specialized packaging and/or transport might be required.

Repairs of an installed door are also problematic due to the long part lengths. Even for small defects or damages a large part needs to be replaced. This leads to a waste of raw material resources.

There is thus a need for improvements in the industry of roll up doors and the side posts of the doors.

### SUMMARY

It is an object of the present disclosure to mitigate, alleviate or eliminate one or more of the above-identified deficiencies and disadvantages in the prior art and solve at least the above mentioned problem. According to a first aspect there is provided a modular side post system for a roll up door comprising a first side post part comprising a profile body comprising a fastening surface arranged to fasten around a door hole of a wall and a slit arranged to guide a door curtain of the roll up door, a first fitting geometry at a first peripheral end of the profile body, and a second fitting geometry at second peripheral end of the profile body; at least one second side post part, wherein the second side post part is identical to the side post part, wherein the first fitting geometry of the first side post part is adapted to fit the second fitting geometry of the second side post part so that the slit of the first side post part continues uninterrupted to the second side post part. Fitting geometry thus means that the geometry is adapted to fit with a corresponding geometry, e.g. as in a plug and socket solution. In this case, as outlined above, the first fitting geometry of the first side post part is adapted to fit the second fitting geometry of the second side post part so that the slit of the first side post part continues uninterrupted to the second side post part.

The profile body could be an open and/or folded metal profile or a hollow profile that may e.g. be extruded. The profile body may be extruded from aluminum. The profile body may also be made and extruded from the material Compodeen, consisting of 72% recycled wood fiber, 24% recycled polypropylene, and 4% additives. Using Compodeen has the advantage of reducing the environmental footprint of the device as the material is almost 100% recycle based and waste can be recycled again into the same material.

The profile body could also be assemblies of metal profiles or pultruded glass fiber/polyester composites.

The problems of the prior art are thereby solved. The modular side post system can be assembled on site by as many first and second parts as needed for the specific door.

Transportation of the parts are simple. The parts could be as short as 0.5 m and can thereby easily be stacked on normal pallets. Cutting waste is greatly reduced as the cut-off part is always below the length of the section parts, e.g. 0.5 m. The cut-off piece can also be used for another side post to even further reduce the waste. The smaller cut-off parts make it easier to keep an inventory for re-use.

Also when it comes to repairs of an installed door the problems of the prior art are addressed. A repair will consume less material as only the damaged section(s) need to be replaced, not the full length profile, resulting in waste reduction.

Smaller part length makes for easier material handling during repairs. Smaller part length also reduce transport weight and volume for the repair team. All repair pieces will fit a standard maintenance van simplifying repair work vastly and reducing costs. Maintenance crews can also keep a stock of modular pieces for urgent repairs which was not possible before.

According to some embodiments, the first fitting geometry is a male fitting geometry, and the second fitting geometry is a female fitting geometry. In that way the pieces of the side post can be assembled together in a simple manner by stacking as many pieces as necessary for the height of the side post.

According to some embodiments, the female fitting geometry extends through substantially the entire profile body. An advantage of this embodiment is that one of the pieces of the modular side post system could be cut to fit the length of the correct width of the door without affecting the female fitting geometry.

According to some embodiments, the first fitting geometry and the second fitting geometry are shaped with protrusions and corresponding respective recesses arranged to lockingly engage with one another when connected. The locking engagement is thus a fitting geometry that is shaped so that the first side post part and the second side post part are locked relative each other when mounted to each other. An advantage of this embodiment is that the parts do not move relative each other during operation, reducing wear and service needs.

According to some embodiments, the first fitting geometry comprises a cross-sectional shape and the second fitting geometry comprises a corresponding cross-sectional shape to form a locking engagement so that the first side post part and the second side post part cannot rotate around a vertical axis and are aligned with each other. This is advantageous as the slit arranged to guide the door sheet or door sections need to remain aligned to firm a slit of the modular side post system without any protrusions due to inaccurate alignment between parts of the modular side post system.

According to some embodiments, the modular side post system comprises a connection piece comprising a third fitting geometry and a fourth fitting geometry, wherein the third fitting geometry is arranged to engage the first fitting geometry of the first side post part; and the fourth fitting geometry is arranged to engage the second fitting geometry of the second side post side post so that the slit of the first side post part continues uninterrupted to the second side post part. According to some embodiments, the first fitting geometry and the second fitting geometry are identical to each other and the third fitting geometry and the fourth fitting geometry are identical to each other.

An advantage of using connection pieces is that that the first fitting geometry of the first side post part and the second side post part and the second fitting geometry of the first side post part and the second part side post part can both be identical and the main body can form both the first fitting geometry and the second fitting geometry where they are both identical.

According to some embodiments, the first fitting geometry and the second fitting geometry are both female fitting geometries and the third fitting geometry and the fourth fitting geometry are both male fitting geometries. Alternatively the first fitting geometry and the second fitting geometry are both male fitting geometries and the third fitting geometry and the fourth fitting geometry are both female fitting geometries.

According to some embodiments, the modular side post system comprises wall fixation means arranged to fixate plural or all parts of the modular side post system to the wall at the door hole. An advantage is that the side post parts can be securely fixated to the wall in a position aligned with the other side post parts so that the slits of the parts form a uniform slit of the side post for the door sheet or door sections.

According to some embodiments, the modular side post system comprises intermediate fixation means arranged to fixate plural or all parts of the modular side post system to each other, wherein the intermediate fixation means is comprised in the group consisting of glue or adhesive, screws, rivets, central rod arranged to pull parts together, central cable arranged to pull parts together, and snap connections. This will securely fasten all parts of the modular side post system to each other effectively stop any movement between the parts which will further reduce wear of the parts leading to reduced service needs of the side posts.

According to a second aspect there is provided a method for arranging a modular side post system for a roll up door at a door hole in a wall comprising arranging at at least one side of the door hole a first side post part comprising a profile body comprising a fastening surface for fastening the profile body to the wall and a slit arranged to guide a door curtain of the roll up door, a first fitting geometry at a first periferal end of the profile body, and a second fitting geometry at second peripheral end of the profile body; arranging adjacent the profile body at least one second side post part, wherein the second side post part is identical to the side post part, aligning the first fitting geometry of the first side post part is to fit the second fitting geometry of the second side post part so that the slit of the first side post part continues uninterrupted to the second side post part.

According to some embodiments, the method comprises securing the modular side post system using wall fixation means arranged to fixate plural or all parts of the modular side post system to the wall at the door hole.

According to some embodiments, the method comprises fixating plural or all parts of the modular side post system to each other using intermediate fixation means comprised in the group consisting of: glue or adhesive, screws, rivets, central rod arranged to pull parts together, central cable arranged to pull parts together, snap connection.

Effects and features of the second aspect are to a large extent analogous to those described above in connection with the first aspect. Embodiments mentioned in relation to the first aspect are largely compatible with the the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a perspective view of a roll up door with side posts and the modular side post system according to an embodiment of the present disclosure.

FIG. 2 shows of the modular side post system according to an embodiment of this disclosure.

FIG. 3 shows of the modular side post system according to an embodiment of this disclosure.

FIG. 4 shows of the modular side post system according to an embodiment of this disclosure.

FIG. 5 is a block diagram showing the method according to the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

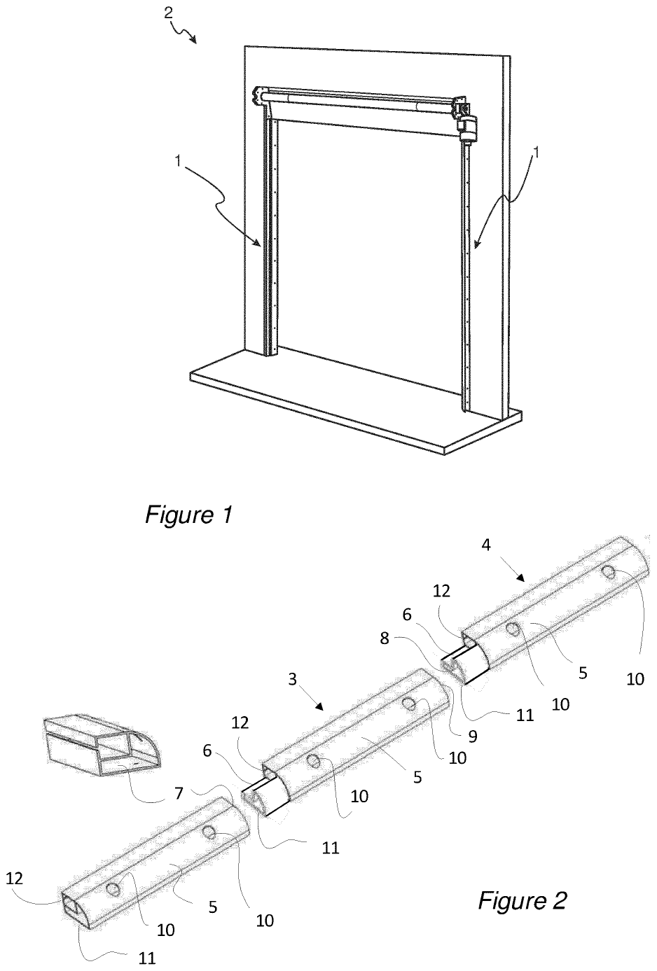

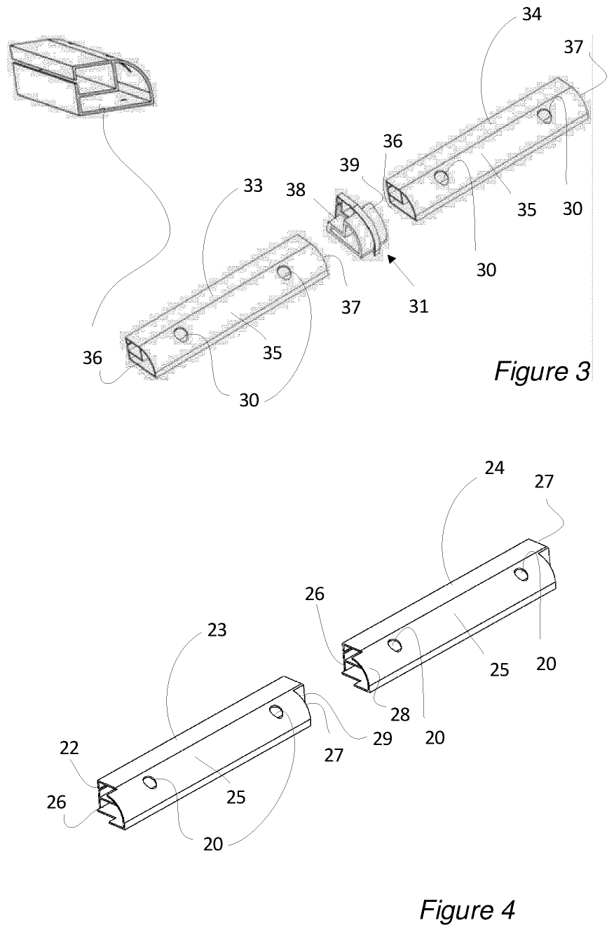

With reference to FIGS. 1, 2 and 3, the first aspect of this disclosure shows a modular side post system 1 for a roll up door 2 comprising a first side post part 3,33 comprising a profile body 5,35 comprising a fastening surface 11 arranged to fasten around a door hole of a wall and a slit 12 arranged to guide a door curtain of the roll up door 2, a first fitting geometry 6,36 at a first peripheral end of the profile body 5,35, and a second fitting geometry 7,37 at second peripheral end of the profile body 5,35; at least one second side post part 4,34, wherein the second side post part is identical to the side post part 3,33, wherein the first fitting geometry 6,36 of the first side post part is adapted to fit the second fitting geometry 7,37 of the second side post part 4,34 so that the slit 12 of the first side post part 3,33 continues uninterrupted to the second side post part 4,34. Fitting geometry thus means that the geometry is adapted to fit with a corresponding geometry. In this case, as disclosed in FIGS. 2 and 3, the first fitting geometry of the first side post part is adapted to fit the second fitting geometry of the second side post part so that the slit of the first side post part continues uninterrupted to the second side post part. In FIG. 2, this is achieved with a male geometry and female geometry as a plug and socket solution.

As seen in the embodiment shown in FIG. 1, the first fitting geometry 6 is a male fitting geometry of the first side post part, and the second fitting geometry 7 of the second side post part is a female fitting geometry. The female fitting geometry 7 extends through substantially the entire profile body.

The modular side post system can be assembled on site by as many first and second parts as needed for the specific door. Transportation of the parts is simplified vastly. The parts could be as short as 0.5 m and can thereby easily be stacked on normal pallets. Cutting waste is greatly reduced as the cut-off part is always below the length of the section parts, e.g. 0.5 m. The cut-off piece can also be used for another side post to even further reduce the waste. The smaller cut-off parts make it easier to keep an inventory for re-use. Also when it comes to repairs of an installed door the problems of the prior art are addressed. A repair will consume less material as only the damaged section(s) need to be replaced replace, not the full length profile, resulting in waste reduction. Smaller part length makes for easier material handling during repairs. Smaller part length also reduce transport weight and volume for the repair team. All repair pieces will fit a standard maintenance van simplifying repair work vastly and reducing costs. Maintenance crews can also keep a stock of modular pieces for urgent repairs which was not possible before.

As seen in FIG. 2 the first fitting geometry comprises a cross-sectional shape 8 and the second fitting geometry comprises a corresponding cross-sectional shape 9 to form a locking engagement so that the first side post part 3 and the second side post part 4 cannot move or rotate and are aligned with each other. The slit 12 will thereby continue smoothly from one part to the next without any obstacles for the door sheet or door sections sliding in the slit 12 during operation of the door.

In the embodiments of FIG. 3 the modular side post system comprises a connection piece 31 comprising a third fitting geometry 38 and a fourth fitting geometry 39, wherein the third fitting geometry 38 is arranged to engage the first fitting geometry 36 of the first side post part 33; and the fourth fitting geometry 39 is arranged to engage the second fitting geometry 37 of the second side post side post 34 so that the slit 12 of the first side post part 3,33 continues uninterrupted to the second side post part 4,34. As seen in FIG. 3, the first fitting geometry 36 and the second fitting geometry 37 are identical to each other and the third fitting geometry 38 and the fourth fitting geometry 39 are identical to each other. In FIG. 3 the first fitting geometry 36 and the second fitting geometry 37 are both female fitting geometries and the third fitting geometry 38 and the fourth fitting geometry 39 are both male fitting geometries. However, it is also possible to have a female connection piece. Using connection pieces 31 simplifies the first side post part 33 and the second side post parts 34 as they can be made as uniform profiles as shown in FIG. 3.

In FIG. 4 the first fitting geometry comprises a cross-sectional shape 28 and the second fitting geometry comprises a corresponding cross-sectional shape 29 to form a locking engagement so that the first side post part 23 and the second side post part 24 cannot move or rotate and are aligned with each other. The slit 22 will thereby continue smoothly from one part to the next without any obstacles for the door sheet or door sections sliding in the slit 22 during operation of the door.

As seen in FIGS. 2, 3 and 4 the modular side post system comprises wall fixation means 10, 30 arranged to fixate plural or all parts of the modular side post system to the wall at the door hole. The side post parts is thereby securely fixated to the wall in a position aligned with the other side post parts so that the slits of the parts form a uniform slit of the side post for the door sheet or door sections.

To further increase the rigidity of the modular side post system, intermediate fixation means (not shown) can be arranged to fixate plural or all parts of the modular side post system to each other. The intermediate fixation means can be glue or adhesive, screws, rivets, central rod arranged to pull parts together, central cable arranged to pull parts together, or snap connections.

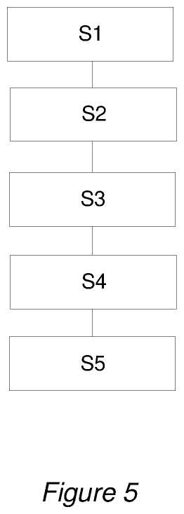

With reference to FIG. 5, the second aspect of this disclosure shows a method for arranging a modular side post system 1 for a roll up door 2 at a door hole in a wall comprising arranging S1 at at least one side of the door hole a first side post part 3,33 comprising a profile body 5,35 comprising a fastening surface 11 for fastening the profile body 5,35 to the wall and a slit 12 arranged to guide a door curtain of the roll up door 2, a first fitting geometry 6,36 at a first periferal end of the profile body 5,35, and a second fitting geometry 7,37 at second peripheral end of the profile body 5,35. At least one second side post part 4,34 is arranged S2 adjacent the profile body 5,35, wherein the second side post part is identical to the side post part 3,33. The first fitting geometry 6,36 of the first side post part is then aligned S3 to fit the second fitting geometry 7,37 of the second side post part 4,34 so that the slit 12 of the first side post part 3,33 continues uninterrupted to the second side post part 4,34.

The modular side post system is secured S4 using wall fixation means 10, 30 arranged to fixate plural or all parts of the modular side post system to the wall at the door hole.

A plurality or all parts of the modular side post system may be fixed S5 to each other using intermediate fixation means as e.g. glue or adhesive, screws, rivets, central rod arranged to pull parts together, central cable arranged to pull parts together, or snap connection.

Exemplary side post systems, and methods are set out in the following items.
1. A modular side post system (1) for a roll up door (2) comprising
a first side post part (3, 33) comprising
   a profile body (5, 35) comprising a fastening surface (11) arranged to fasten around a door hole of a wall and a slit (12) arranged to guide a door curtain of the roll up door (2),
   a first fitting geometry (6, 36) at a first peripheral end of the profile body (5, 35), and
   a second fitting geometry (7, 37) at second peripheral end of the profile body (5, 35);
at least one second side post part (4, 34), wherein the second side post part is identical to the side post part (3, 33),
wherein the first fitting geometry (6, 36) of the first side post part is adapted to fit the second fitting geometry (7, 37) of the second side post part (4, 34) so that the slit (12) of the first side post part (3, 33) continues uninterrupted to the second side post part (4, 34).
2. The modular side post system according to item 1, wherein the first fitting geometry (6) is a male fitting geometry, and the second fitting geometry (7) is a female fitting geometry.
3. The modular side post system according to item 2, wherein the female fitting geometry (7) extends through substantially the entire profile body.
4. The modular side post system according to any one of the preceding items, wherein
   the first fitting geometry and the second fitting geometry are arranged to lockingly engage with one another when connected.
5. The modular side post system according to any one of the preceding items, wherein
   the first fitting geometry comprises a cross-sectional shape and the second fitting geometry comprises a corresponding cross-sectional shape to form a locking engagement so that the first side post part (3) and the second side post part (4) cannot move and are aligned with each other.
6. The modular side post system according to item 1, further comprising a connection
   piece (31) comprising a third fitting geometry (38) and a fourth fitting geometry (39), wherein
the third fitting geometry (38) is arranged to engage the first fitting geometry (36) of the first side post part (33); and
the fourth fitting geometry (39) is arranged to engage the second fitting geometry (37) of the second side post side post (34) so that the slit (12) of the first side post part (3, 33) continues uninterrupted to the second side post part (4, 34).
7. The modular side post system according to item 6, wherein the first fitting geometry (36) and the second fitting geometry (37) are identical to each other and the third fitting geometry (38) and the fourth fitting geometry (39) are identical to each other.
8. The modular side post system according to item 6 or item 7, wherein the first fitting
   geometry (36) and the second fitting geometry (37) are both female fitting geometries and the third fitting geometry (38) and the
   fourth fitting geometry (39) are both male fitting geometries.
9. The modular side post system according to any one of the preceding items, further
   comprising wall fixation means (35) arranged to fixate plural or all parts of the modular side post system to the wall at the door hole.
10. The modular side post system according to any one of the preceding items, further
   comprising intermediate fixation means arranged to fixate plural or all parts of the modular side post system to each other, wherein the intermediate fixation means is comprised in the group consisting of glue or adhesive, screws, rivets, central rod arranged to pull parts together, central cable arranged to pull parts together, and snap connections.
11. A method for arranging a modular side post system (1) for a roll up door (2) at a door
   hole in a wall comprising
arranging (S1) at at least one side of the door hole a first side post part (3, 33) comprising
   a profile body (5, 35) comprising a fastening surface (11) for fastening the profile body (5, 35) to the wall and a slit (12) arranged to guide a door curtain of the roll up door (2),
   a first fitting geometry (6, 36) at a first peripheral end of the profile body (5, 35), and
   a second fitting geometry (7, 37) at second peripheral end of the profile body (5, 35);
arranging (S2) adjacent the profile body (5, 35) at least one second side post part (4, 34), wherein the second side post part is identical to the side post part (3, 33),
aligning (S3) the first fitting geometry (6, 36) of the first side post part is to fit the second fitting geometry (7, 37) of the second side post part (4, 34) so that the slit (12) of the first side post part (3, 33) continues uninterrupted to the second side post part (4, 34).
12. The method according to item 11, further comprising securing (S4) the side system using wall fixation means arranged to fixate plural or all parts of the modular side post system to the wall at the door hole.
13. The method according to item 11 or 12, further comprising
fixating (S5) plural or all parts of the modular side post system to each other using intermediate fixation means comprised in the group consisting of: glue or adhesive, screws, rivets, central rod arranged to pull parts together, central cable arranged to pull parts together, snap connection.

The person skilled in the art realizes that the present disclosure is not limited to the preferred embodiments described above. The person skilled in the art further realizes that modifications and variations are possible within the scope of the appended claims. For example. Additionally, variations to the disclosed embodiments can be understood and effected by the skilled person in practicing the claimed disclosure, from a study of the drawings, the disclosure, and the appended claims.

1. A modular side post system (1) for a roll up door (2) comprising
a first side post part (3, 23, 33) comprising
a profile body (5, 25, 35) comprising a fastening surface (11) arranged to fasten around a door hole of a wall and a slit (12) arranged to guide a door curtain of the roll up door (2),
a first fitting geometry (6, 26, 36) at a first peripheral end of the profile body (5, 25, 35), and
a second fitting geometry (7, 27, 37) at second peripheral end of the profile body (5, 35);
at least one second side post part (4, 24, 34), wherein the second side post part is identical to the side post part (3, 23, 33), wherein the first fitting geometry (6, 36) of the first side post part is adapted to fit the second fitting geometry (7, 27, 37) of the second side post part (4, 24, 34) so that the slit (12) of the first side post part (3, 23, 33) continues uninterrupted to the second side post part (4, 24, 34).

2. The modular side post system according to claim 1, wherein the first fitting geometry (6) is a male fitting geometry, and the second fitting geometry (7) is a female fitting geometry.

3. The modular side post system according to claim 2, wherein the female fitting geometry (7) extends through substantially the entire profile body.

4. The modular side post system according to claim 1, wherein the first fitting geometry (6, 26) and the second fitting geometry (7, 27) are shaped with protrusions (8, 28) and corresponding respective recesses (9, 29) arranged to lockingly engage with one another when connected.

5. The modular side post system according to claim 1, wherein the first fitting geometry (6, 26, 36) comprises a cross-sectional shape (28) and the second fitting geometry (7, 27, 37) comprises a corresponding cross-sectional shape (29) to form a locking engagement so that the first side post part (3) and the second side post part (4) cannot rotate around a vertical axis and are aligned with each other.

6. The modular side post system according to claim 1, further comprising a connection
piece (31) comprising a third fitting geometry (38) and a fourth fitting geometry (39), wherein the third fitting geometry (38) is arranged to engage the first fitting geometry (36) of the first side post part (33); and
the fourth fitting geometry (39) is arranged to engage the second fitting geometry (37) of the second side post side post (34) so that the slit (12) of the first side post part (3, 23, 33) continues uninterrupted to the second side post part (4, 24, 34).

7. The modular side post system according to claim 6, wherein the first fitting geometry (36) and the second fitting geometry (37) are identical to each other and the third fitting geometry (38) and the fourth fitting geometry (39) are identical to each other.

8. The modular side post system according to claim 6, wherein the first fitting
geometry (36) and the second fitting geometry (37) are both female fitting geometries and the third fitting geometry (38) and the fourth fitting geometry (39) are both male fitting geometries.

9. The modular side post system according to claim 1, further comprising wall fixation means (35) arranged to fixate plural or all parts of the modular side post system to the wall at the door hole.

10. The modular side post system according to claim 1, further comprising intermediate fixation means arranged to fixate plural or all parts of the modular side post system to each other, wherein the intermediate fixation means is comprised in the group consisting of glue or adhesive, screws, rivets, central rod arranged to pull parts together, central cable arranged to pull parts together, and snap connections.

11. A method for arranging a modular side post system (1) for a roll up door (2) at a door hole in a wall comprising
arranging (S1) at at least one side of the door hole a first side post part (3, 33) comprising
a profile body (5, 35) comprising a fastening surface (11) for fastening the profile body (5, 35) to the wall and a slit (12) arranged to guide a door curtain of the roll up door (2),
a first fitting geometry (6, 36) at a first peripheral end of the profile body (5, 35), and
a second fitting geometry (7, 37) at second peripheral end of the profile body (5, 35);
arranging (S2) adjacent the profile body (5, 35) at least one second side post part (4, 34), wherein the second side post part is identical to the side post part (3, 33),
aligning (S3) the first fitting geometry (6, 36) of the first side post part is to fit the second fitting geometry (7, 37) of the second side post part (4, 34) so that the slit (12) of the first side post part (3, 33) continues uninterrupted to the second side post part (4, 34).

12. The method according to claim 11, further comprising securing (S4) the side post
system using wall fixation means arranged to fixate plural or all parts of the modular side post system to the wall at the door hole.

13. The method according to claim 11, further comprising fixating (S5) plural or all parts of the modular side post system to each other using intermediate fixation means comprised in the group consisting of: glue or adhesive, screws, rivets, central rod arranged to pull parts together, central cable arranged to pull parts together, snap connection.
